(19) United States
(12) Patent Application Publication
(10) Pub. No.: US 2017/0217743 A1
(43) Pub. Date: Aug. 3, 2017

(54) TIRE LIFTER

(71) Applicant: Eian Douglas Mathieson, St. Ives (AU)

(72) Inventor: Eian Douglas Mathieson, St. Ives (AU)

(73) Assignees: Eian Douglas Mathieson, St. Ives (AU); Professional Tool Products LLC, Travelers Rest, SC (US)

(21) Appl. No.: 15/146,968

(22) Filed: May 5, 2016

Related U.S. Application Data
(63) Continuation-in-part of application No. 15/011,079, filed on Jan. 29, 2016, now abandoned.

(51) Int. Cl. B66F 5/02; B66F 5/00; B66F 5/04

(52) U.S. Cl. CPC B66F 5/025; B66F 5/04; B66F 5/00

(57) ABSTRACT

A tire lifter is provided having a horizontal frame in a vertical support, the horizontal frame providing for wheel movement of the tire lifter. A drive lift mechanism is positioned within the vertical upright of the frame and includes a screw drive that is used to raise and lower a pair of support arms which cradle a tire or a tire and wheel combination. Further, the support arms which cradle the tire can also be adjusted in a forward and rearward direction to allow for easier placement of a tire relative to an automobile.

### RELATED APPLICATIONS

This application is a continuation-in-part of U.S. patent application Ser. No. 15/011,079 filed on Jan. 29, 2016 and which claims the benefit and priority to the Chinese Utility Application having a Publication No. 201420749514.2 filed on Dec. 3, 2014. Both applications are incorporated herein by reference.

### FIELD OF THE INVENTION

This invention relates to a lifting apparatus to help in the installation and removal of a tire and/or a tire/wheel combination.

### BACKGROUND OF THE INVENTION

This invention relates to automotive tires and wheels which require regular maintenance including rotation, balancing, repair, and replacement. Traditionally, the changing of a tire is done by a technician who manually removes the wheel or tire from the vehicle when the vehicle is on a hoist or lift. The lifting and carrying of a tire and wheel involves considerable exertion and can result in injuries to a worker. As the popularity of SUVs, pick-up trucks, and light trucks/delivery vans increase, the associated weight of tires and tire and wheel combinations is increasing. In addition, it is increasingly common in many countries to have worker safety laws that limit the amount a person can lift, the limit usually being in the range of 20-25 kgs. Accordingly, there is a need to provide for improvements in the tools, apparatuses and techniques in which one can use to more safely remove and install tires and tire/wheel combinations to and from a motor vehicle.

Accordingly, there remains room for improvement and variation within the art.

### SUMMARY OF THE INVENTION

It is one aspect of at least one of the present embodiments to provide for a lifting apparatus for a tire mounted on a rim comprising:
a frame having a horizontal base and a vertical upright;
a plurality of wheels supported by the horizontal base;
a lifting mechanism secured within an interior channel defined by the vertical upright, the lift mechanism adapted to selectively raise and lower a pair of support arms, the support arms adapted for engaging a tire and rim combination; wherein the support arms are further adapted for lateral movement through apertures defined by a horizontal support.

It is one aspect of at least one of the present embodiments to provide for a lifting apparatus comprising an adjustable height vertical support bar adapted, for engaging an upper surface of a tire mounted on a rim so as to provide a stabilizing force.

It is one aspect of at least one of the present embodiments to provide for a lifting apparatus wherein the adjustable vertical support bar may be rotated to position the support bar relative to a support tire.

It is one aspect of at least one of the present embodiments to provide for a lifting apparatus wherein the lifting mechanism can be actuated by use of a manual handle.

It is one aspect of at least one of the present embodiments to provide for a lifting apparatus wherein the lifting mechanism can be actuated by use of an electric motor.

It is one aspect of at least one of the present embodiments to provide for a lifting apparatus wherein the lifting mechanism is a screw drive.

It is one aspect of at least one of the present embodiments to provide for a lifting apparatus wherein the lifting mechanism can be actuated by use of a hydraulic cylinder.

It is one aspect of at least one of the present embodiments to provide for a lifting apparatus wherein the lifting mechanism can be actuated by use of a pneumatic cylinder.

It is one aspect of at least one of the present embodiments to provide for a lifting apparatus wherein a gear box is in communication with the lifting mechanism and the gear box is adapted for receiving a rotary drive tool that can be used to raise and lower the pair of support arms.

It is one aspect of at least one of the present embodiments to provide for a lifting apparatus in which a gear box is adapted for receiving a rotary drive tool that could be used to raise and lower a pair of support arms. The drive box is accessible through either a horizontal rotary drive tool or a vertically positioned drive tool, the gear box having a configuration to allow the use of a drive tool in either orientation.

It is one aspect of at least one of the present embodiments to provide for a lifting apparatus wherein the gear box further defines a step down gear mechanism that will limit the rate at which the support arms can be raised and lowered when engaged by a rotary drive tool.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 is a perspective view of one embodiment of the present invention.

FIG. 2 is a front view of the tire lifter seen in FIG. 1.

FIG. 3 is a side view of a tire lifter as seen in FIGS. 1 and 2.

FIG. 4 is a view of an alternative embodiment of the present invention.

### DESCRIPTION OF THE PREFERRED EMBODIMENT

Reference will now be made in detail to the embodiments of the invention. one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

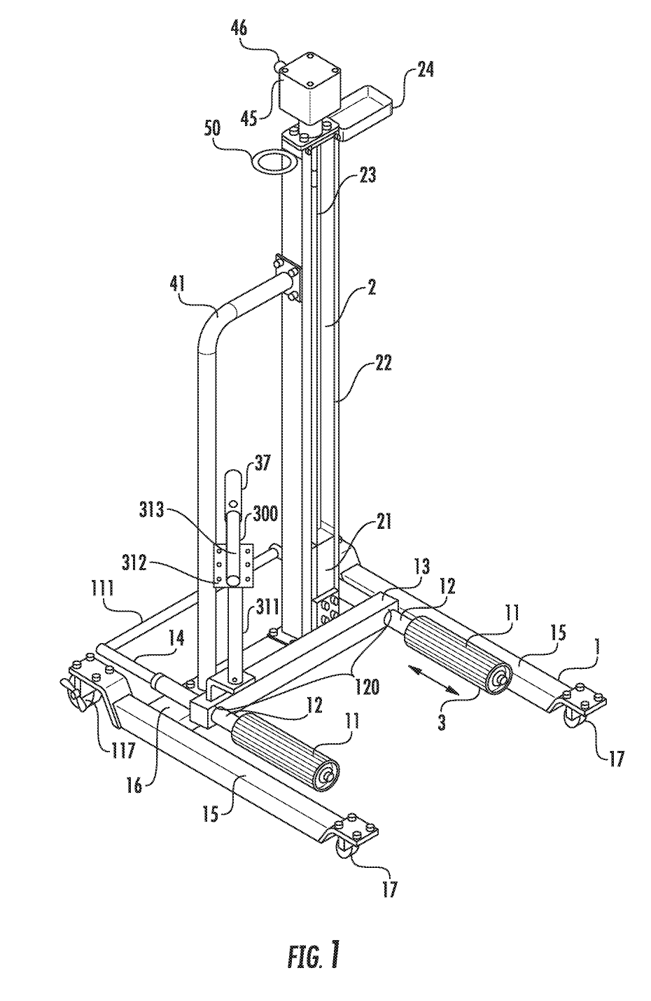

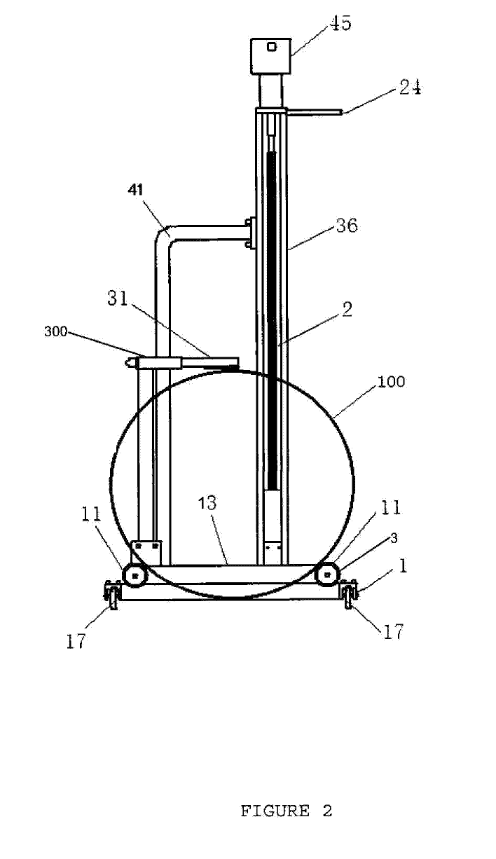

In reference to FIGS. 1 and 2, a tire lifter is illustrated. As used herein, the term “tire”, when referenced with the lifting apparatus, can refer to a tire, a tire mounted on a wheel or rim, or a tire wheel without a mounted tire.

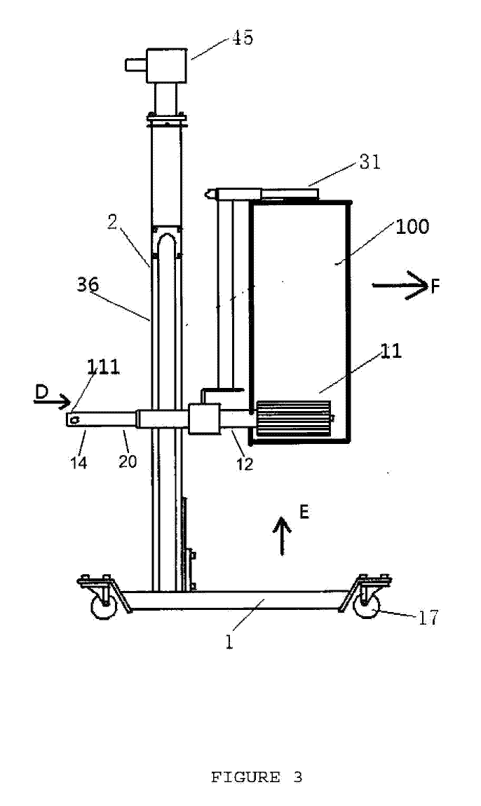

As best seen in reference to FIGS. 1 and 3, a pair of support arms 11 are positioned within a plane defined by the horizontal base and provide a support or cradle for retaining a tire 100. Support arms 12 define a first terminal end 14 which will allow a telescopic sliding motion of the support arms to allow positioning of a tire 100 to be varied front to back as seen by directional arrows D and F in FIG. 3. Terminal end 14 slides within an insertion of arm 12 and is supported by roller bearings within arms 12 for smooth movement even when supporting a heavy load. A connecting bar 111 (FIG. 1) may be provided which connects the two terminal, ends 14 of support arms 12 to allow the coordinated movement and sliding of the pair of support arms 12. The support arms 12 are retained within a horizontal bar 13 and passed through defined apertures 120.

The support arms 12 may optionally be provided with a surface covering 3 which may be of a rubber, plastic, or nylon material to provide better friction and gripping of a supported tire 100.

As best seen in reference to FIG. 1, mechanical stops 20 can be in the form of a seated ring or protrusion on the surface of the support arms 12 to limit the lateral distance in which the supporting arms can be extended in a forward direction. Similarly, the surface coverings 3, which may engage a surface of the support arms 12, will serve as mechanical stops to limit the backward movement of the support arms 12.

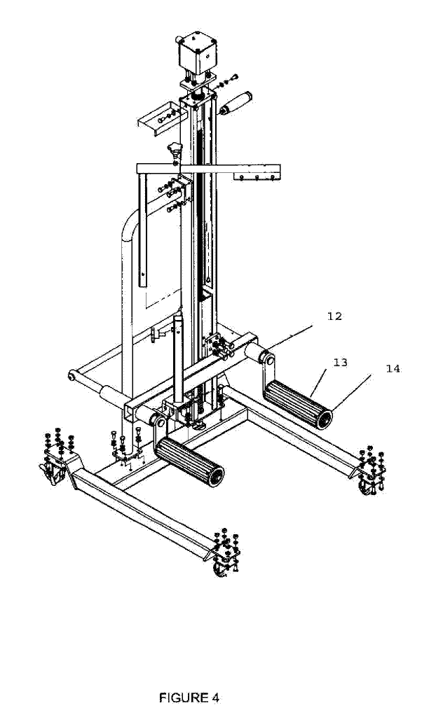

As set forth in FIG. 4, an alternative embodiment of the support arms 12 as seen in which each end of support arms 12 define a tire engaging cradle portion 14 which is positioned in a plane parallel to and below the plane of the support arm 12. Maintaining the cradle portion 14 in a lower plane provides for a cradle which will engage a work surface of the floor while maintaining the arms 12 and terminal portions 14 several inches above the work space floor providing greater clearance between the moving parts and the work floor surface.

As seen in reference to FIG. 1, each support arm 12 is secured through the apertures 120 defined by horizontal bar 13, horizontal bar 13 further attached to a slide block 21 positioned within the channel 22 defined by vertical upright 36. As slide block 21 is raised and lowered by screw rod 23, the horizontal bar 13, support arms 11, and pull bar 111 are similarly moved in an up and down direction as seen by directional arrow E in FIG. 3.

The illustrated embodiment shows a screw rod 23 as part of a lifting mechanism and is connected to a gear box 45. Gear box 45 may be controlled by a manual handle to engage the gear box and the screw rod, an electric motor, or the gear box may define an optional shaft 46 which can engage a rotary hand tool such as a drill or a pneumatic wrench. The hand tools allow operation of the lifting mechanism and when the gear box is configured for operation with such a rotary tool, a gear reducer may be employed within the gear box to prevent an excessive speed in raising or lowering the supported tire. While shaft 46 is illustrated so as to engage a rotary tool in a horizontal orientation, it is well within the skill level one of ordinary skill in the art to configure the gear box 45 such that the shaft 46 is accessible by a tool which is presented and maintained in a vertical orientation.

The horizontal bar 13 can additionally support a tire retainer bracket 300 comprising a vertical support bar 311 and a retractable bar 313 connected to an upper terminus of support bar 311. Retractable bar 313 is able to rotate relative to a vertical axis defined by support bar 311. A terminal end of retaining bar 313 defines a press plate 312 designed to engage an upper surface of a tire 100 and the tire is supported within the support arms 11. Relative movement of the retractable bar 313 in both a lateral as well as a vertical positioning allows the press plate 312 to be positioned to provide a stabilizing downward clamping pressure on the tire to prevent unwanted movement of the supported tire.

The handle 40 may be provided which connects the vertical upright 36 to a connection bar 16, the connection bar 16 additionally secured to each side member of the horizontal frame. Handle 40 facilitates movement of the wheeled tire lifting apparatus.

As seen in FIG. 1, a work tray 24 may be attached to the vertical upright 36 and is useful for holding lug nuts, valve stems, tire weights, and similar items used when servicing a tire. As further seen in FIG. 1, a circular retaining ring 50 may also be provided which is designed to hold a hand tool such as a pneumatic impact wrench or a rotary drive tool.

While the illustrated embodiment discloses a drive screw mechanism for lifting and lowering the support arms 11, it is understood and appreciated by those having ordinary skill in the art that other types of lifting mechanisms could be employed. For instance, a hydraulic or pneumatic piston could, be used to raise and lower the support bars. Similarly, a pulley system could be used within the vertical upright to facilitate the raising and lowering of the support arms.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole, or in part. Therefore, the spirit and scope of the appended claims should not be limited to the description of the preferred versions contained therein.

That which is claimed:

1. A lifting apparatus for a tire mounted on a rim comprising:
a frame having a horizontal base and a vertical upright;
a plurality of wheels supported by the horizontal base;
a lifting mechanism secured within an interior channel defined by the vertical upright, the lift mechanism adapted to selectively raise and lower a pair of support arms, the support arms adapted for engaging a tire and rim combination;
wherein the support arms are laterally moveable through apertures defined by a horizontal support bar of the horizontal base, and at a perpendicular angle relative to the vertical upright, the support arm being further connected to a handle.

2. The lifting apparatus according to claim 1, further comprising an adjustable height vertical support bar, adapted for engaging an upper surface of a tire mounted on a rim so as to provide a stabilizing force.

3. The lifting apparatus according to claim 2 wherein the adjustable vertical support bar may be rotated to position the support bar relative to a support bar.

4. The lifting apparatus according to claim 1 wherein the lifting mechanism can be actuated by use of a manual handle.

5. The lifting apparatus according to claim 1 wherein the lifting mechanism can be actuated by use of a electric motor.

6. The lifting apparatus according to claim 1 wherein the lifting mechanism is a screw drive.

7. The lifting apparatus according to claim 1 wherein the lifting mechanism can be actuated by use of a hydraulic cylinder.

8. The lifting apparatus according to claim 1 wherein the lifting mechanism can be actuated by use of a pneumatic cylinder.

9. A lifting apparatus according to claim 1 wherein a gear box is in communication with the lifting mechanism and the gear box is adapted for receiving a rotary drive tool that can be used to raise and lower the pair of support arms.

10. The lifting apparatus according, to claim 9 wherein the gear box further defines a step down gear mechanism that will limit the rate at which the support arms can be raised and lowered when engaged by a the rotary drive tool.

11. The lifting apparatus according to claim 1 wherein the support arms are positioned opposite a first side of the vertical upright and the handle is attached to the horizontal support bar on a second and opposite side of the vertical upright.

12. The lifting apparatus according to claim 1 wherein the handle is positioned between the support arms.

13. The lifting apparatus according to claim 1 wherein the support arm, the horizontal support bar, and the handle can be raised and lowered relative to the vertical upright.

14. The lifting apparatus according to claim 1 wherein the lifting apparatus further defines a press plate adapted for operatively engaging with an upper portion of a tire when the tire is supported within the support arms, the press plate being carried by the horizontal support bar.

15. The lifting apparatus according to claim 14 wherein the press plate is rotatable relative to a vertical axis of a vertical support member secured to the horizontal support bar.
